(19) United States
(12) Patent Application Publication
(10) Pub. No.: US 2023/0208177 A1
(43) Pub. Date: Jun. 29, 2023

(54) Method For Driving The Charging And Discharging Of A Plurality Of Electrical Energy Storage Device

(71) Applicant: Electricite de France, Paris (FR)

(72) Inventors: Julian Freytes, Versailles (FR); Bogdan Dzonlaga, Noisy Rudignon (FR)

(73) Assignee: Electricite de France, Paris (FR)

(21) Appl. No.: 18/071,185

(22) Filed: Nov. 29, 2022

(30) Foreign Application Priority Data
Dec. 3, 2021 (FR) 2112962

(51) Int. Cl. H02J 7/00; H02J 7/34

(52) U.S. Cl. CPC H02J 7/00712; H02J 7/0048; H02J 7/0013; H02J 7/342; H02J 2207/20

(57) ABSTRACT

The invention relates to a method for driving the charging and discharging of a plurality of electrical energy storage devices connected to a common connection point (PCC) of an electrical distribution network, as a function of variation of a requested power value (Pₜ^{ref}) at the common connection point, each electrical energy storage device (i) presenting a respective instantaneous state of charge (SOCᵢ), comprising steps of:

a—determining a number of electrical energy storage devices needed (N_{needed}) to provide the requested power value at a time t,
b—activating and/or deactivating one or more of the electrical energy storage devices, as a function of the determined number of electrical energy storage devices needed (N_{needed}), and the values of the instantaneous states of charge (SOCᵢ) of each of the electrical energy storage devices (i), and
c—distributing the requested power (Pₜ^{ref}) between the activated electrical energy storage devices.

### FIELD OF THE INVENTION

The invention relates to a method for driving the charging and discharging of a plurality of electrical energy storage devices.

### STATE OF THE ART

Electrical energy distribution networks generally include electrical energy storage devices. These electrical energy storage devices have the function of storing and restoring electrical energy, for example to compensate for variations in the production of electrical energy by some electrical production equipment operating intermittently (for example photovoltaic panels and wind turbines) or to be able to cope with power demand peaks by avoiding having to oversize the electrical production equipment connected to the network.

These electrical energy storage devices generally comprise battery assemblies and inverters, each inverter converting the direct current provided by the battery assemblies into alternating current intended to supply the electrical energy distribution network.

Several electrical energy storage devices can be connected to the same connection point, called “common connection point” (PCC), of the electrical energy distribution network. In this case, a drive system allows distributing in real time the electrical power drawn from each electrical energy storage device as a function of the requested total power at the common connection point.

Several drive strategies can be implemented by the drive system.

A first strategy consists in dividing the requested total power at the common connection point, equally between the electrical energy storage devices connected to the common connection point. In this way, all electrical energy storage devices are activated at the same time and provide equal fractions of the requested total power.

However, this first strategy is not optimal, because in the case where the requested total power at the common connection point is low, each electrical energy storage device is activated to provide a very low power. However, the operation of the inverters generates incompressible electrical losses (conduction losses and switching losses), while the power provided is very low.

In addition, the simultaneous activation of all the electrical energy storage devices accelerates the aging of the batteries.

A second strategy consists in determining part of the power to be requested from each electrical energy storage device, as a function of a difference between the state of charge of the electrical energy storage device and an average state of charge determined on the set of the electrical energy storage devices. With this second strategy, an electrical energy storage device that has a state of charge far from the average state of charge is more loaded than a device that has a state of charge close to the average state of charge.

This second strategy tends to balance the states of charge of the electrical energy storage devices, by converging the different states of charge towards the same average state of charge.

However, this second strategy also has the drawback of simultaneously loading all the electrical energy storage devices, which is not efficient when the requested total power is low. In addition, this second strategy also generates an accelerated aging of the batteries.

### SUMMARY OF THE INVENTION

One aim of the invention is to propose a method for driving the charging and discharging of a plurality of electrical energy storage devices, which is more efficient, that is to say which generates less electrical losses for an identical requested total power.

This aim is achieved within the scope of the present invention, thanks to a method for driving the charging and discharging of a plurality of electrical energy storage devices connected to a common connection point (PCC) of an electrical distribution network, as a function of a variation of a requested total power value (Pₜ^{ref}) at the common connection point, each electrical energy storage device (i) presenting a respective instantaneous state of charge (SOCᵢ), comprising steps of:
a—determining a number of electrical energy storage devices needed (N_{needed}) to provide the requested total power value at a time t, the number of electrical energy storage devices needed (N_{needed}) being determined such that:
   if the requested total power value decreases, the number of electrical energy storage devices needed (N_{needed}) is the maximum number N of electrical energy storage devices, such that the requested total power value divided by the number N is above a first predefined power threshold (threshold OFF), and
   if the requested total power value increases, the number of electrical energy storage devices needed (N_{needed}) is the minimum number N of electrical energy storage devices, such that the requested power value divided by the number N is below a second predefined power threshold (threshold ON),
b—activating and/or deactivating one or more of the electrical energy storage devices, as a function of the determined number of electrical energy storage devices needed (N_{needed}), and the values of the instantaneous states of charge (SOCᵢ) of each of the electrical energy storage devices (i), and
c—distributing the requested total power (Pₜ^{ref}) between the activated electrical energy storage devices.

In such a method, the fraction of the power requested from each electrical storage device is always above the first predefined power threshold or the second predefined power threshold.

Indeed, this drive method can be implemented so as to:
deactivate an electrical energy storage device, only if the power requested from each active electrical energy storage device becomes below the first predefined power threshold, and
activate an electrical energy storage device, only if the power requested from each active electrical energy storage device falls below the second predefined power threshold.

This avoids simultaneously loading all the electrical energy storage devices and consequently limits the electrical losses and the accelerated aging of the electrical energy storage devices.

The first predefined power threshold and the second predefined power threshold can be identical.

However, in one preferred embodiment of the method, the second predefined power threshold (threshold ON) is above the first power threshold (threshold OFF), which allows minimizing the number of activations and deactivations of the electrical energy storage devices, when the power requested from each device is close to the predefined power threshold.

According to one possible embodiment of the method, step b comprises sub-steps of:

d—if the requested power value is positive, determining a maximum instantaneous state of charge value among the state of charge values (SOCᵢ) of the electrical energy storage devices,
e—comparing the instantaneous state of charge value (SOCᵢ) of each electrical energy storage device with the maximum instantaneous state of charge value,
f—selecting the electrical energy storage devices capable of being activated, as being the electrical energy storage devices which have an instantaneous state of charge above the maximum instantaneous state of charge value minus a first predefined tolerance value (SOCₜₒₗ).

According to one possible embodiment of the method, step b comprises sub-steps of:

g—if the requested power value is negative, determining a minimum instantaneous state of charge value among the state of charge values (SOCᵢ) of the electrical energy storage devices,
h—comparing the instantaneous state of charge value (SOCᵢ) of each electrical energy storage device with the minimum instantaneous state of charge value,
i—selecting the electrical energy storage devices capable of being activated, as being the electrical energy storage devices which have an instantaneous state of charge below the minimum instantaneous state of charge value plus a second predefined tolerance value (SOCₜₒₗ).

According to one possible embodiment of the method, step b further comprises sub-steps of:

j—determining a number of electrical energy storage devices capable of being activated (N_{active}),
k—comparing the number of electrical energy storage devices capable of being activated (N_{active}) with the number of electrical energy storage devices needed (N_{needed})_{I} and
l—if the number of electrical energy storage devices capable of being activated (N_{active}) is equal to the number of electrical energy storage devices needed (N_{needed})_{I} activating the electrical energy storage devices capable of being activated,
m—if the number of electrical energy storage devices capable of being activated (N_{active}) is above the number of electrical energy storage devices needed (N_{needed})_{I} activating only part of the electrical energy storage devices capable of being activated,
o—if the number of electrical energy storage devices capable of being activated (N_{active}) is below the number of electrical energy storage devices needed (N_{needed})_{I} activating the electrical energy storage devices capable of being activated and one or more additional electrical energy storage devices.

According to one possible embodiment of the method, in the case where the number of electrical energy storage devices capable of being activated (N_{active}) is above the number of electrical energy storage devices needed (N_{needed}), the step m comprises:
if the requested power value is negative, activating the electrical energy storage devices with the lowest state of charge values, among the electrical energy storage devices capable of being activated,
if the requested power value is positive, activating the electrical energy storage devices with the highest state of charge values, among the electrical energy storage devices capable of being activated.

According to one possible embodiment of the method, in the case where the number of electrical energy storage devices capable of being activated (N_{active}) is below the number of electrical energy storage devices needed (N_{needed}), step o comprises:
if the requested power value is negative, activating the electrical energy storage devices capable of being activated, as well as one or more additional electrical energy storage devices with the lowest state of charge values among the electrical energy storage devices which has (have) not been selected as electrical energy storage device(s) capable of being activated,
if the requested power value is positive, activating the electrical energy storage devices capable of being activated, as well as one or more additional electrical energy storage devices with the highest state of charge values among the electrical energy storage devices which has (have) not been selected as electrical energy storage device(s) capable of being activated.

According to one possible embodiment of the method, steps j to o are repeated over time so as to activate and/or deactivate, as the states of charge values change, electrical energy storage devices.

According to one possible embodiment of the method, the method comprises a step of:

p—applying a charge and discharge cycle to an electrical energy storage device chosen among the plurality of electrical energy storage devices, so that during the charge and discharge cycle, electrical energy is transferred between the chosen electrical energy storage device and the other electrical energy storage devices,
q—measuring a capacity of the chosen electrical energy storage device, as a function of variations of the measured electrical parameters of the electrical energy storage device over time during the charge and discharge cycle, and wherein steps a to c are applied to the plurality of electrical energy storage devices except for the electrical energy storage device chosen.

The invention further relates to a computer program product comprising program code instructions for the execution of the steps of a drive method as defined previously, when this program is executed by a computer.

The invention also relates to a device for driving the charging and discharging of a plurality of electrical energy storage devices connected to a common connection point (PCC) of an electrical distribution network, comprising a processor and a memory in which a program is recorded comprising instructions for the implementation by the processor of a drive method as defined previously.

### PRESENTATION OF THE DRAWINGS

Other characteristics and advantages will emerge from the following description, which is purely illustrative, and should be read in relation to the appended figures, in which:

FIG. 1 schematically represents part of an electrical energy distribution network comprising a plurality of electrical energy storage devices and a device for driving the charging and discharging of the electrical energy storage devices,

FIG. 2 schematically represents the device for driving the charging and discharging of the electrical energy storage devices,

FIG. 3A and FIG. 3B schematically represent steps of a method for driving the charging and discharging of the electrical energy storage devices,

FIG. 4 is a diagram schematically representing a variation of the number of electrical energy storage devices needed over time, as a function of the requested power, for an example of variation of the requested total power over time,

FIG. 5 is a diagram schematically representing an example of variation of the fraction of the power requested from an electrical energy storage device over time,

FIG. 6 is a diagram schematically representing a variation of the total power requested from the set of the electrical energy storage devices over time, a variation of the fraction of the power requested from each electrical energy storage device over time, a variation of the states of charge of the electrical energy storage devices over time, and the state of the electrical energy storage devices (activated or deactivated) over time, for a conventional drive method, not implementing the invention,

FIG. 7 is a diagram schematically representing a variation of the total power requested from the set of the electrical energy storage devices over time, a variation of the fraction of the power requested from each electrical energy storage device over time, a variation of the states of charge of the electrical energy storage devices over time, and the state of the electrical energy storage devices (activated or deactivated) over time, for a drive method in accordance with one embodiment of the invention,

FIG. 8 is a diagram schematically representing the level of the electrical losses for a conventional drive method, not implementing the invention, and for a drive method in accordance with one embodiment of the invention,

FIG. 9 is a diagram schematically representing a variation of the total power requested from the set of the electrical energy storage devices over time, a variation of the fraction of the power requested from each electrical energy storage device over time, a variation of the states of charge of the electrical energy storage devices over time, and the state of the electrical energy storage devices (activated or deactivated) over time, for a drive method in accordance with one embodiment of the invention, in which a charge and discharge cycle is applied to one of the electrical energy storage devices.

### DETAILED DESCRIPTION OF ONE EMBODIMENT OF THE INVENTION

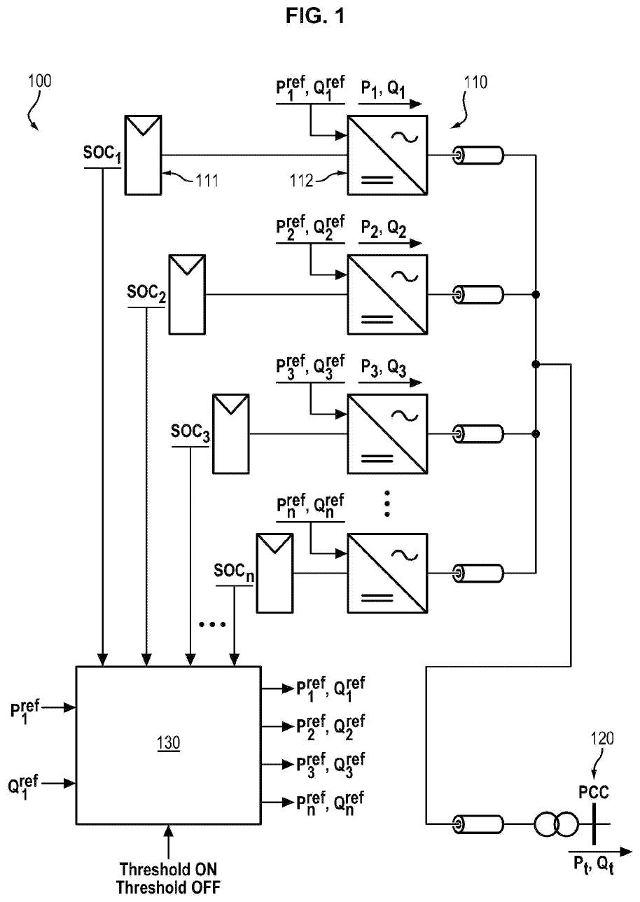

In FIG. 1, the part of the electrical energy distribution network represented 100 comprises a plurality of electrical energy storage devices 110, connected to a common connection point (PCC) 120 of the electrical distribution network.

More specifically, the part of the electrical energy distribution network represented 100 comprises a number n of electrical energy storage devices 110.

Each electrical energy storage device 110 comprises a battery assembly 111 and an inverter 112 suitable for converting a direct current provided by the battery assembly 111 into an alternating current intended to supply the common connection point 120 of the electrical energy distribution network 100. A battery assembly 111 can for example comprise from 1 to 40 battery(ies).

Thus, each battery assembly 111 is connected to the common connection point 120 through a respective inverter 112.

Each battery assembly i presents a state of charge, whose instantaneous value is SOCᵢ.

The part of the electrical energy distribution network 100 further comprises a device for driving the charging and discharging 130 of the electrical energy storage devices 110.

The drive device 130 is suitable for receiving as input a signal representative of a requested total power value Pₜ^{ref} at the common connection point 120, and generating as output control signals for the electrical energy storage devices. More specifically, each control signal generated as output by the drive device is a signal representative of a power value Pᵢ^{ref} to be provided by the electrical energy storage device i.

The power values Pᵢ^{ref} to be provided by the electrical energy storage devices 1 to n are such that:

$${\sum }_{i = 1}^{n} {P}_{i}^{ref} = {P}_{t}^{ref}$$

It should be noted that the requested total power value Pₜ^{ref} at the common connection point 120 can be positive or negative. By convention, in the case where the value of Pₜ^{ref} is positive, it means that the electrical energy storage devices 110 are providing electrical power to the rest of the electrical distribution network via the common electrical connection point 120, that is to say, the electrical energy storage devices are discharging. Conversely, in the case where the value of Pₜ^{ref} is negative, it means that the electrical energy storage devices 110 are receiving electrical power from the rest of the electrical distribution network via the common connection point 120, that is to say the electrical energy storage devices 110 are charging.

The drive device 130 can comprise a microprocessor and a memory in which a program is recorded comprising instructions for the implementation of a method for driving the charging and discharging of the electrical energy storage devices. When it executes the program, the processor is suitable for determining in real time the power values Pᵢ^{ref} to be provided by the electrical energy storage devices i, as a function of the requested total power value Pₜ^{ref} at the common connection point 120 and the states of charge values SOCᵢ of the electrical energy storage devices i.

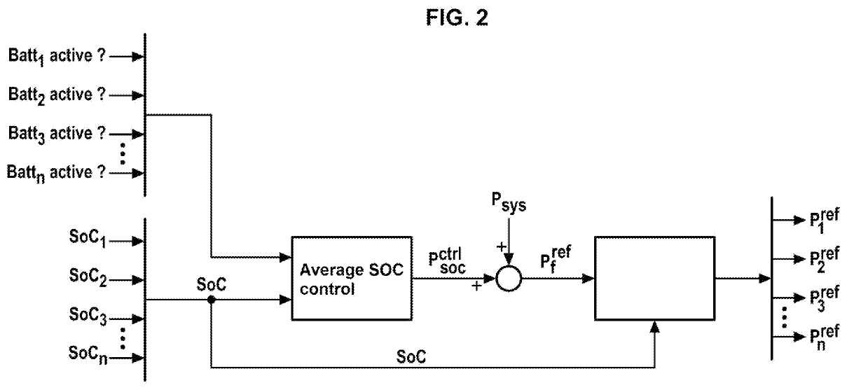

FIG. 2 schematically represents the way in which the requested total power value Pₜ^{ref} is determined. A cascade control receives a power P_{sys} to be provided by the electrical energy storage devices 110 to provide service systems, necessary for the operation of the electrical distribution network, in addition to the transmission and distribution of electrical energy (these service systems can for example include a control of the frequency of the electrical distribution network, a control of the voltage provided by the electrical distribution network, a power restoration, an operational management of the electrical distribution network) and calculates the power Pₜ^{ref}=P_{sys}+P_{soc}^{ctrl}, in which P_{soc}^{ctrl} controls the average state of charge of the set of the electrical energy storage devices.

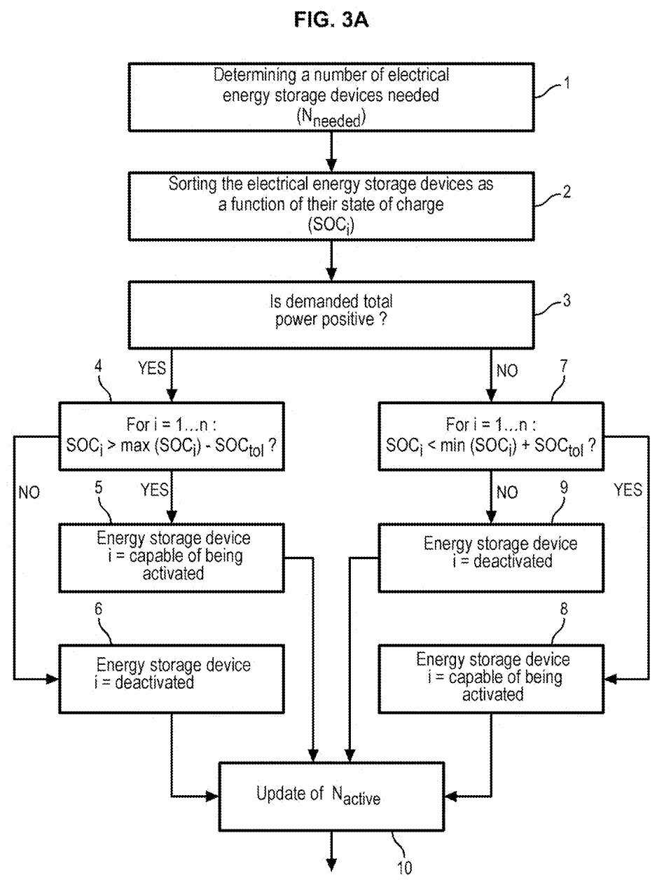

In FIGS. 3A and 3B, the method for driving the charging and discharging of the electrical energy storage devices comprises the following steps.

According to a first step 1, the drive device 130 determines a number of electrical energy storage devices needed N_{needed} to provide the requested total power value at a time t.

The number of electrical energy storage devices needed N_{needed} is determined such that:

if the requested total power value Pₜ^{ref} decreases, the number of electrical energy storage devices needed N_{needed} is the maximum number N of electrical energy storage devices, such that the requested total power value divided by the number N is above a first predefined power threshold threshold OFF, and

if the requested total power value Pₜ^{ref} increases, the number of electrical energy storage devices needed N_{needed} is the minimum number N of electrical energy storage devices, such that the requested power value divided by the number N is below a second predefined power threshold (threshold ON).

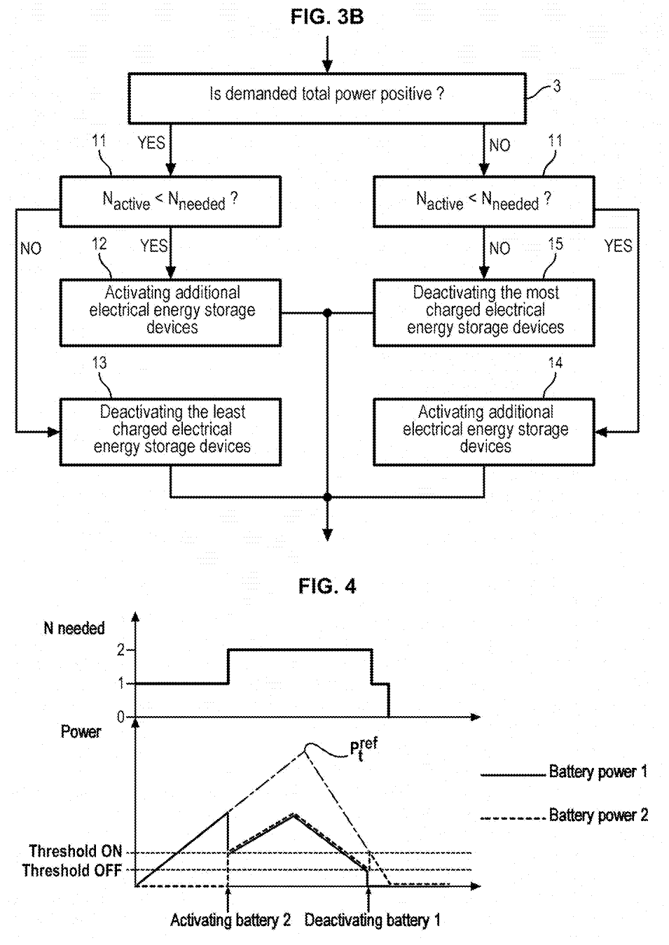

FIG. 4 shows an example of variation of the number of electrical energy storage devices needed N_{needed} over time as a function of the variation of the requested total power Pₜ^{ref} over time.

In this example, the value of the requested total power Pₜ^{ref} increases linearly during a first period of time from a zero value to a maximum value, then decreases linearly during a second period of time, which follows the first period of time, from the maximum value to a zero value.

At the beginning of the first period of time, only one electrical energy storage device is needed (N_{needed}=1) to provide the requested total power Pₜ^{ref}. Thus, only one electrical energy storage device is activated. Then, when the requested total power reaches a value equal to twice the second predefined power threshold threshold ON, two electrical energy storage devices are needed (N_{needed}=2). Thus, a second electrical energy storage device is activated.

The two electrical energy storage devices remain activated as long as the power requested from each energy storage device is above the first predefined power threshold threshold OFF. In other words, the two electrical energy storage devices remain activated as long as the requested total power is above twice the first predefined power threshold threshold OFF.

During the second period of time, the requested total power Pₜ^{ref} decreases. When the requested total power falls below twice the first predefined power threshold threshold OFF, only one electrical energy storage device is needed (N_{needed}=1). Thus, one of the electrical energy storage devices is deactivated.

In this way, when more than one electrical energy storage device is activated, each electrical energy storage device activated still provides a power that cannot be below a minimum power.

As illustrated in FIG. 4, the first power threshold thresholdOFF and the second predefined power threshold thresholdON are chosen so that the second predefined power threshold thresholdON is above the first power threshold thresholdOFF. This allows creating hysteresis in the cycle of activation and deactivation of the electrical energy storage devices, and thus minimizing the activation and deactivation of the electrical energy storage devices.

According to a second step 2, the drive device 130 sorts the electrical energy storage devices i as a function of their state of charge SOCᵢ.

For example, the electrical energy storage devices are sorted in an ascending state of charge order, that is to say going from the electrical energy storage device with the lowest state of charge to the electrical energy storage device with the highest state of charge.

According to a third step 3, the drive device 130 determines whether the requested total power is positive.

If the requested total power Pₜ^{ref} is positive, it means that the electrical energy storage devices are providing electrical power to the rest of the electrical distribution network, that is to say the electrical energy storage devices are discharging.

If the requested total power Pₜ^{ref} is negative, it means that the electrical energy storage devices are receiving electrical power from the rest of the electrical distribution network, that is to say the electrical energy storage devices are charging.

According to a fourth step 4, if the requested total power is positive, then the drive device 130 compares the instantaneous state of charge value SOCᵢ of each electrical energy storage device i with the maximum instantaneous state of charge value max (SOCᵢ).

According to a fifth step 5, for each device i, if the instantaneous state of charge value SOCᵢ is above the maximum instantaneous state of charge value minus a first predefined tolerance value:

SOCᵢ>max(SOCᵢ)−SOCₜₒₗ
then the drive device 130 selects the electrical energy storage device i as being capable of being activated.

According to a sixth step 6, for each device i, if the instantaneous state of charge value SOCᵢ is below the maximum instantaneous state of charge value minus the first predefined tolerance value:

SOCᵢ<max(SOCᵢ)−SOCₜₒₗ
then the drive device 130 selects the electrical energy storage device i as being deactivated.

According to a seventh step 7, if the requested total power Pₜ^{ref} is negative, then the drive device 130 compares the instantaneous state of charge value SOCᵢ of each electrical energy storage device i with the minimum instantaneous state of charge value (min(SOCᵢ).

According to an eighth step 8, for each device i, if the instantaneous state of charge value SOCᵢ is below the minimum instantaneous state of charge value plus a second predefined tolerance value:

(SOCᵢ)<min(SOCᵢ)+SOCₜₒₗ
then the drive device 130 selects the electrical energy storage device i as being capable of being activated.

According to a ninth step 9, for each device i, if the instantaneous state of charge value SOCᵢ is below the minimum instantaneous state of charge value plus the second predefined tolerance value:

SOCᵢ>min(SOCᵢ)+SOCₜₒₗ
then the drive device 130 selects the electrical energy storage device i as being deactivated.

According to a tenth step 10, the drive device determines a number N_{active} of electrical energy storage devices capable of being activated.

In parallel, according to an eleventh step 11, the drive device compares the number of electrical energy storage devices capable of being activated N_{active} with the number of electrical energy storage devices needed N_{needed}.

According to a twelfth step 12, if the requested total power Pₜ^{ref} is positive and if the number of electrical energy storage devices capable of being activated N_{active} is below the number of electrical energy storage devices needed N_{needed}, the drive device 130 activates the electrical energy storage devices capable of being activated and one or more additional electrical energy storage devices.

More specifically, the additional electrical energy storage device(s) is (are) the electrical energy storage device(s) with the highest state of charge values among the electrical energy storage devices that has (have) not been selected as electrical energy storage device(s) capable of being activated.

According to a thirteenth step 13, if the requested total power Pₜ^{ref} is positive and if the number of electrical energy storage devices capable of being activated N_{active} is above the number of electrical energy storage devices needed N_{needed}, the drive device 130 activates only part of the electrical energy storage devices capable of being activated.

More specifically, the drive device 130 activates the electrical energy storage devices capable of being activated with the highest state of charge values among the electrical energy storage devices that have been selected as electrical energy storage devices capable of being activated.

In other words, the drive device 130 deactivates the least charged electrical energy storage devices, among the electrical energy storage devices capable of being activated.

According to a fourteenth step 14, if the requested total power is negative and if the number of electrical energy storage devices capable of being activated N_{active} is below the number of electrical energy storage devices needed N_{needed}, the drive device 130 activates the electrical energy storage devices capable of being activated and one or more additional electrical energy storage devices.

More specifically, the additional electrical energy storage device(s) is (are) the electrical energy storage device(s) with the lowest state of charge values among the electrical energy storage devices that has (have) not been selected as electrical energy storage device(s) capable of being activated.

According to a fifteenth step 15, if the requested total power Pₜ^{ref} is negative and if the number of electrical energy storage devices capable of being activated N_{active} is above the number of electrical energy storage devices needed N_{needed}, the drive device 130 activates only part of the electrical energy storage devices capable of being activated.

More specifically, the drive device 130 activates the electrical energy storage devices capable of being activated with the lowest state of charge values among the electrical energy storage devices that have been selected as electrical energy storage devices capable of being activated.

In other words, the drive device 130 deactivates the most charged electrical energy storage devices, among the electrical energy storage devices capable of being activated.

In this way, the number of electrical energy storage devices is still equal to the number of electrical energy storage devices needed N_{needed}.

The drive device 130 repeats steps 4 to 15, so that for a given number of electrical energy storage devices needed N_{needed}, the drive device activates and/or deactivates electrical energy storage devices to take into account variations of the states of charge of the different electrical energy storage devices over time.

In addition, the drive device 130 renews steps 1 to 3 so as to update the number of electrical energy storage devices needed N_{needed} as a function of the variations of the requested total power Pₜ^{ref} at the common connection point 120.

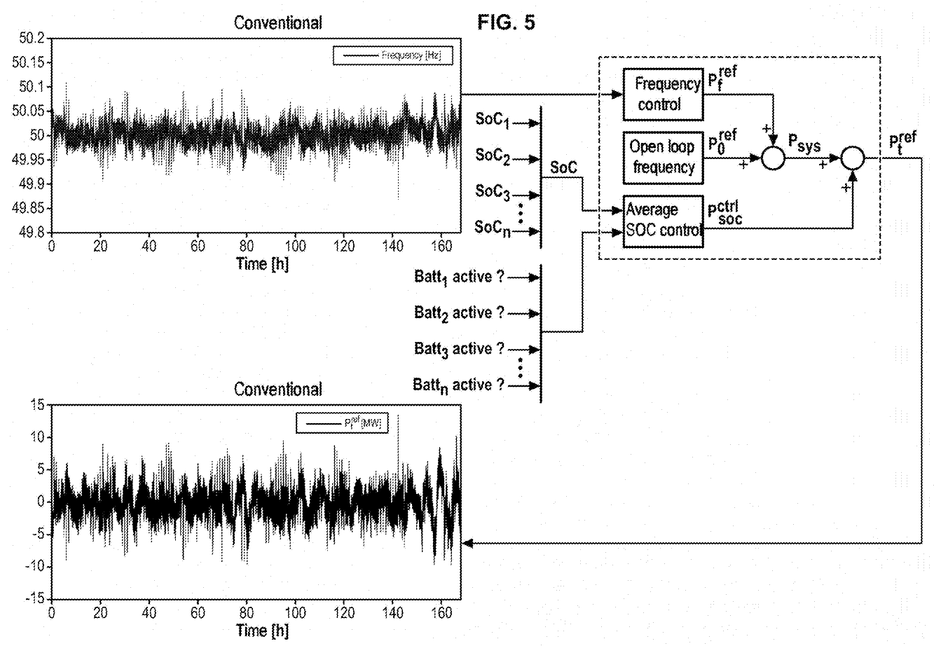

FIG. 5 is a diagram schematically representing an example of variation of the fraction of the power requested from an electrical energy storage device over time.

In this example, four electrical energy storage devices are connected to the common connection point. The requested total power Pₜ^{ref} at the common connection point is determined as a function of a frequency of the electrical distribution network. More specifically, in the example illustrated in FIG. 5, the requested total power Pₜ^{ref} at the common connection point is determined as a sum of three power components P_{f}^{ref}, P₀^{ref} and P_{SOC}^{ref}.

The first power component P_{f}^{ref} depends on the frequency of the electrical distribution network.

Indeed, the frequency of an electrical distribution network must be maintained at a predefined nominal frequency value throughout the operation of the electrical distribution network. For example, in France, the value of the nominal frequency of an electrical distribution network is 50 Hertz.

If the frequency of the electrical distribution network drops, this means that the consumption increases and that the electrical production equipment must provide more electrical energy to the network. In this situation, the electrical energy storage devices can contribute to providing electrical energy to the electrical distribution network.

If the frequency of the electrical distribution network increases, it means that the consumption decreases and that the electrical production equipment must provide less energy. In this situation, the electrical energy storage devices can absorb the excess electrical energy produced by this electrical production equipment (for example by photovoltaic panels or wind turbines).

The frequency of the electrical distribution network is therefore one of the parameters that allow monitoring the production/consumption state in the electrical distribution network.

As illustrated in FIG. 5, the first component Pᵣ^{ref} is therefore determined as a function of a measured value of the frequency of the electrical distribution network. For example, the first power component Pᵣ^{ref} can be determined as being inversely proportional to a difference between the measured value of the frequency of the electrical distribution network and the predefined nominal frequency value.

The second power component P₀^{ref} can be determined as a function of a value requested by the manager of the electrical distribution network, in order to meet a particular power demand. By default, the second power component P₀^{ref} can be 0.

The third power component P_{SOC}^{ref} depends on the average of the states of charge SOCᵢ of the electrical energy storage devices i activated. For example, the third power component P_{SOC}^{ref} can be determined as being inversely proportional to a difference between an average value SOC_{avg} of the states of charge SOCᵢ of the electrical energy storage devices i activated and an average reference value SOC_{avg}^{ref}.

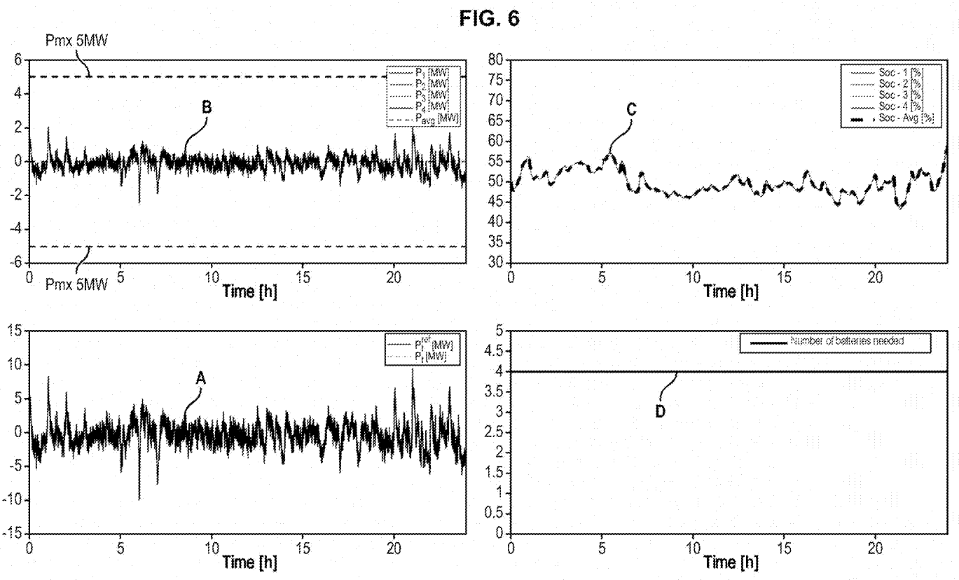

In FIG. 6, the curve A represents a variation of the total power Pₜ^{ref} requested from the set of the electrical energy storage devices over time.

In this example, four electrical energy storage devices are connected to the common connection point.

The curve B represents a variation of the fraction of the power requested from each electrical energy storage device over time when a conventional drive method, not implementing the invention, is applied, considering four electrical energy storage connected to the common connection point. The electrical energy storage devices each produce an identical fraction of the requested power. In addition, the value of the power provided by each electrical energy storage device is low.

The curve C represents the variations of the states of charge of the different electrical energy storage devices over time obtained with the conventional drive method, not implementing the invention. In such a drive method, the states of charge of the different electrical energy storage devices follow identical variations. The states of charge are identical over time.

The curve D represents the states of the different electrical energy storage devices (activated or deactivated) over time obtained with the conventional control method, not implementing the invention. In such a drive method, the electrical energy storage devices are all activated permanently.

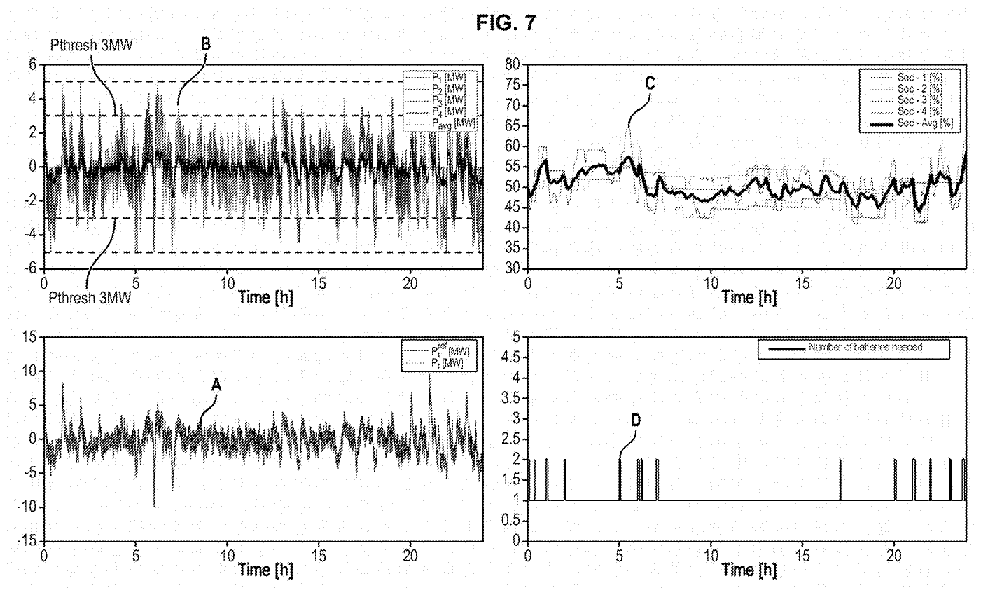

By way of comparison, in FIG. 7, the curve A represents a variation of the total power requested from the set of the electrical energy storage devices over time in a drive method in accordance with one embodiment of the invention.

In this example, four electrical energy storage devices are connected to the common connection point.

The curve B represents the variations of the different fractions of the power requested from the different electrical energy storage devices over time in the drive method in accordance with one embodiment of the invention. The powers provided by the different electrical energy storage devices are different. In addition, the power provided by each electrical energy storage device varies with an amplitude much above the amplitude of variation of the power provided in the case of a conventional drive method.

The curve C represents the variations of the states of charge of the different electrical energy storage devices over time in the drive method in accordance with one embodiment of the invention. In such a drive method, the states of charge of the different electrical energy storage devices are not identical over time, but vary such that the differences between the states of charge of the electrical energy storage devices remain within a range of predefined values.

The curve D represents the states of the electrical energy storage devices (activated or deactivated) over time in the drive method in accordance with one embodiment of the invention. In such a drive method, the electrical energy storage devices are not activated permanently. The number of electrical energy storage devices activated changes over time as a function of the value of the requested total power at the common connection point.

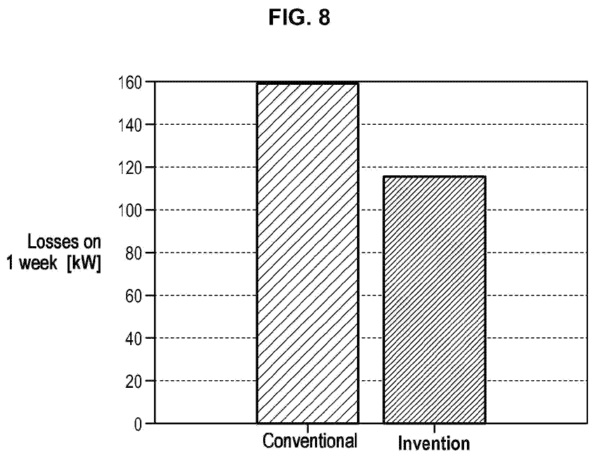

FIG. 8 is a diagram schematically representing the level of electrical losses for a conventional drive method, not implementing the invention (Conventional), and for a drive method in accordance with one embodiment of the invention (Invention). In this example, the drive method in accordance with one embodiment of the invention allows reducing the electrical losses of the inverters by 28% compared to the conventional drive method, not implementing the invention.

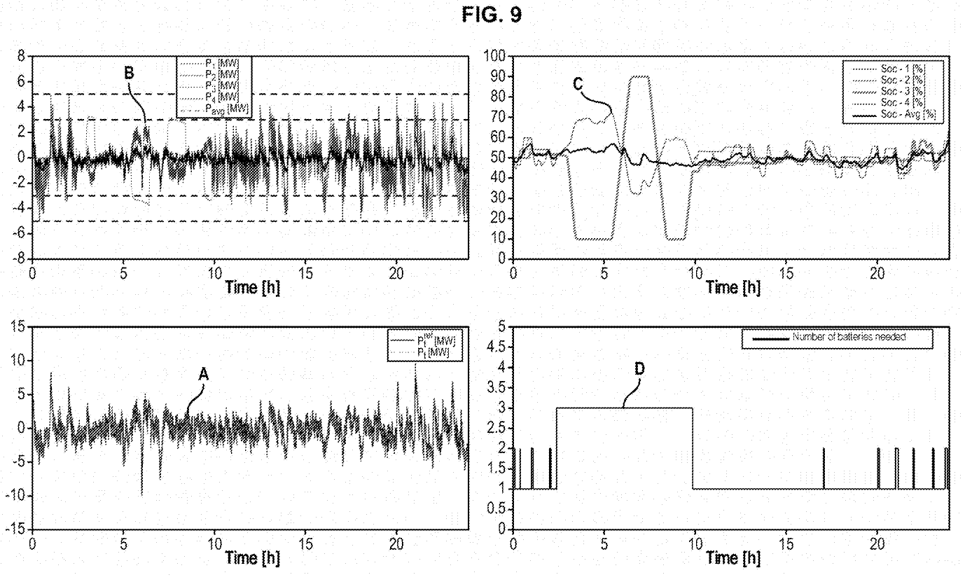

In FIG. 9, a charge and discharge cycle, visible on curve C, is imposed on one of the electrical energy storage devices chosen among the set of the electrical energy storage devices. During the charge and discharge cycle, electrical energy is transferred between the electrical energy storage device chosen and the other electrical energy storage devices.

During the charge and discharge cycle, a value of the capacity of the electrical energy storage device chosen is determined, in order to recalibrate an estimator of the state of charge of the electrical energy storage device. In a known manner, the state of charge of the electrical energy storage device is determined as a function of the variations of measured electrical parameters over time, during the charge and discharge cycle. The measured electrical parameters are an electrical current delivered by the electrical energy storage device, a voltage across the electrical energy storage device and a temperature of the electrical energy storage device.

The charge and discharge cycle is imposed on the electrical energy storage device chosen while a drive method in accordance with one embodiment of the invention is applied to the other electrical energy storage devices.

As shown in FIG. 9, the drive method automatically adapts to the additional variations of the states of charge of the electrical energy storage devices due to the transfer of electrical energy between the electrical energy storage device being calibrated and the other electrical energy storage devices. Thus, the method allows charging and discharging an electrical energy storage device chosen without disturbing the electrical power provided at the common connection point.

1. A method for driving the charging and discharging of a plurality of electrical energy storage devices connected to a common connection point (PCC) of an electrical distribution network, as a function of a variation of a requested power value (Pₜ^{ref}) at the common connection point, each electrical energy storage device (i) presenting a respective instantaneous state of charge (SOCᵢ), comprising steps of:
a—determining a number of electrical energy storage devices needed (N_{needed}) to provide the requested power value at a time t, the number of electrical energy storage devices needed (N_{needed}) being determined such that:
if the requested power value decreases, the number of electrical energy storage devices needed (N_{needed}) is the maximum number N of electrical energy storage devices, such that the requested power value divided by the number N is above a first predefined power threshold (threshold OFF), and
if the requested power value increases, the number of electrical energy storage devices needed (N_{needed}) is the minimum number N of electrical energy storage devices, such that the requested power value divided by the number N is below a second predefined power threshold (threshold ON),
b—activating and/or deactivating one or more of the electrical energy storage devices, as a function of the determined number of electrical energy storage devices needed (N_{needed}), and the values of the instantaneous states of charge (SOCᵢ) of each of the electrical energy storage devices (i), and
c—distributing the requested power (Pₜ^{ref}) between the activated electrical energy storage devices.

2. The method according to claim 1, wherein the second predefined power threshold (threshold ON) is above the first power threshold (threshold OFF).

3. The method according to claim 1, wherein step b comprises sub-steps of:
d—if the requested power value is positive, determining a maximum instantaneous state of charge value among the state of charge values (SOCᵢ) of the electrical energy storage devices,
e—comparing the instantaneous state of charge value (SOCᵢ) of each electrical energy storage device with the maximum instantaneous state of charge value,
f—selecting the electrical energy storage devices capable of being activated, as being the electrical energy storage devices which have an instantaneous state of charge above the maximum instantaneous state of charge value minus a first predefined tolerance value (SOCₜₒₗ).

4. The method according to claim 1, wherein step b comprises sub-steps of:
g—if the requested power value is negative, determining a minimum instantaneous state of charge value among the state of charge values (SOCᵢ) of the electrical energy storage devices,
h—comparing the instantaneous state of charge value (SOCᵢ) of each electrical energy storage device with the minimum instantaneous state of charge value,
i—selecting the electrical energy storage devices capable of being activated, as being the electrical energy storage devices which have an instantaneous state of charge below the minimum instantaneous state of charge value plus a second predefined tolerance value (SOCₜₒₗ).

5. The method according to claim 3, wherein step b further comprises sub-steps of:
j—determining a number of electrical energy storage devices capable of being activated (N_{active}),
k—comparing the number of electrical energy storage devices capable of being activated (N_{active}) with the number of electrical energy storage devices needed (N_{needed}), and
l—if the number of electrical energy storage devices capable of being activated (N_{active}) is equal to the number of electrical energy storage devices needed (N_{needed}), activating the electrical energy storage devices capable of being activated,
m—if the number of electrical energy storage devices capable of being activated (N_{active}) is above the number of electrical energy storage devices needed (N_{needed}), activating only part of the electrical energy storage devices capable of being activated,
o—if the number of electrical energy storage devices capable of being activated (N_{active}) is below the number of electrical energy storage devices needed (N_{needed}), activating the electrical energy storage devices capable of being activated and one or more additional electrical energy storage devices.

6. The method according to claim 5, wherein, in the case where the number of electrical energy storage devices capable of being activated (N_{active}) is above the number of electrical energy storage devices needed (N_{needed}), the step m comprises:
if the requested power value is negative, activating the electrical energy storage devices with the lowest state of charge values, among the electrical energy storage devices capable of being activated,
if the requested power value is positive, activating the electrical energy storage devices with the highest state of charge values, among the electrical energy storage devices capable of being activated.

7. The method according to claim 5, wherein, in the case where the number of electrical energy storage devices capable of being activated (N_{active}) is below the number of electrical energy storage devices needed (N_{needed}), step o comprises:
if the requested power value is negative, activating the electrical energy storage devices capable of being activated, as well as one or more additional electrical energy storage devices with the lowest state of charge values among the electrical energy storage devices which has (have) not been selected as electrical energy storage device(s) capable of being activated,
if the requested power value is positive, activating the electrical energy storage devices capable of being activated, as well as one or more additional electrical energy storage devices with the highest state of charge values among the electrical energy storage devices which has (have) not been selected as electrical energy storage device(s) capable of being activated.

8. The method according to claim 5, wherein steps j to o are repeated over time so as to activate and/or deactivate, as the states of charge values change, electrical energy storage devices.

9. The method according to claim 1, comprising a step of:
p—applying a charge and discharge cycle to an electrical energy storage device chosen among the plurality of electrical energy storage devices, so that during the charge and discharge cycle, electrical energy is transferred between the chosen electrical energy storage device and the other electrical energy storage devices,
q—measuring a capacity of the chosen electrical energy storage device, as a function of variations of the measured electrical parameters of the electrical energy storage device over time during the charge and discharge cycle, and
wherein steps a to c are applied to the plurality of electrical energy storage devices except for the electrical energy storage device chosen.

10. A computer program product comprising program code instructions for the execution of the steps of a drive method in accordance with claim 1, when this program is executed by a computer.

11. A device for driving the charging and discharging of a plurality of electrical energy storage devices connected to a common connection point (PCC) of an electrical distribution network, comprising a processor and a memory in which a program is recorded comprising instructions for the implementation by the processor of a drive method in accordance with claim 1.

12. The method according to claim 2, wherein step b comprises sub-steps of:
d—if the requested power value is positive, determining a maximum instantaneous state of charge value among the state of charge values (SOCᵢ) of the electrical energy storage devices,
e—comparing the instantaneous state of charge value (SOCᵢ) of each electrical energy storage device with the maximum instantaneous state of charge value,
f—selecting the electrical energy storage devices capable of being activated, as being the electrical energy storage devices, which have an instantaneous state of charge above the maximum instantaneous state of charge value minus a first predefined tolerance value (SOCₜₒₗ).

13. The method according to claim 2, wherein step b comprises sub-steps of:
g—if the requested power value is negative, determining a minimum instantaneous state of charge value among the state of charge values (SOCᵢ) of the electrical energy storage devices,
h—comparing the instantaneous state of charge value (SOCᵢ) of each electrical energy storage device with the minimum instantaneous state of charge value,
i—selecting the electrical energy storage devices capable of being activated, as being the electrical energy storage devices, which have an instantaneous state of charge below the minimum instantaneous state of charge value plus a second predefined tolerance value (SOCₜₒₗ).

14. The method according to claim 12, wherein step b comprises sub-steps of:
g—if the requested power value is negative, determining a minimum instantaneous state of charge value among the state of charge values (SOCᵢ) of the electrical energy storage devices,
h—comparing the instantaneous state of charge value (SOCᵢ) of each electrical energy storage device with the minimum instantaneous state of charge value,
i—selecting the electrical energy storage devices capable of being activated, as being the electrical energy storage devices, which have an instantaneous state of charge below the minimum instantaneous state of charge value plus a second predefined tolerance value (SOCₜₒₗ).

15. A computer program product comprising program code instructions for the execution of the steps of a drive method in accordance with claim 2, when this program is executed by a computer.

16. A device for driving the charging and discharging of a plurality of electrical energy storage devices connected to a common connection point (PCC) of an electrical distribution network, comprising a processor and a memory in which a program is recorded comprising instructions for the implementation by the processor of a drive method in accordance with claim 2.

17. The method according to claim 2, comprising a step of:
p—applying a charge and discharge cycle to an electrical energy storage device chosen among the plurality of electrical energy storage devices, so that during the charge and discharge cycle, electrical energy is transferred between the chosen electrical energy storage device and the other electrical energy storage devices,
q—measuring a capacity of the chosen electrical energy storage device, as a function of variations of the measured electrical parameters of the electrical energy storage device over time during the charge and discharge cycle, and
wherein steps a to c are applied to the plurality of electrical energy storage devices except for the electrical energy storage device chosen.
